(19) United States
(12) Patent Application Publication
(10) Pub. No.: US 2008/0263562 A1
(43) Pub. Date: Oct. 23, 2008

(54) Management Information System for Allocating Contractors with Requestors

(75) Inventor: David Serwitz, San Luis Obispo, CA (US)

Correspondence Address: LAW OFFICE OF PHILIP A STEINER, 1212 MARSH STREET, SUITE 3, SAN LUIS OBISPO, CA, 93401, US

(73) Assignees: David Serwitz, San Luis Obispo, CA (US); Grade Potential, San Luis Obispo, CA (US)

(21) Appl. No.: 12/027,254

(22) Filed: Feb. 6, 2008

Related U.S. Application Data
(63) Continuation of application No. 11/736,368, filed on Apr. 17, 2007.

(51) Int. Cl. G06F 9/50

(52) U.S. Cl. 718/105

(57) ABSTRACT

A management information system, computer implemented method and computer product for allocating contractors and requestors. A networked server is provided which includes a processor, a memory coupled to the processor and a database operatively stored in the memory. The database comprises a first database component operative to maintain a plurality of contract service records, each contract service record being associated with a contractor and including contractor data representing an available contract services and a contractor locality; a second database component is operative to maintain a plurality of requester records, each requester record being associated with an individual requester and including requester data representing a requested contract service and a requester locality. A database engine is operatively loaded into the memory and includes instructions executable by the processor to determine a suggested contractor/requestor allocation in dependence on a correspondence of at least the data representing a contract service and locality among the contract services records and requester records and output a suggested contractor/requestor allocation in a tiered order of preference of contractors and sends notices to the identified contractors.

### CROSS-REFERENCE TO RELATED APPLICATIONS

This application is a continuation of co-pending U.S. patent application Ser. No. 11/736,368, filed Apr. 17, 2007 to the instant inventor which is hereby incorporated by reference in its entirety as if fully set forth herein.

### FEDERALLY SPONSORED RESEARCH AND DEVELOPMENT

Not Applicable

### REFERENCE TO A MICROFICHE APPENDIX

Not Applicable

### RELEVANT INVENTIVE FIELD

The various inventive embodiments relates generally to management information systems and more specifically to a system, method and computer program product for a management information system associated with arranging for contractual service.

### BACKGROUND

People and/or business entities desiring contract assistance generally have limited choices in obtaining personalized contractor assistance. In many cases, the contract assistance is provided at a time and/or place more convenient to the contractor but not that of the requestor. Moreover, the quality of provided contractual services tends to be unknown and requires additional investigative efforts in order to ensure satisfactory service.

For example, a homeowner may be in need of repairs for an electrical appliance. Typically, the homeowner locates a repair service using a telephone book or possibly using online by performing a search on the worldwide web. However, in most cases, the homeowner has little control over the scheduling of the repairs and usually has to wait around for hours to ensure meeting the repair person at an agreed to date and time. In addition, there is little assurance that the retained repair service is competent to perform the requested services and/or offers the best service for the price.

In a business context, a common contractual service request arises for catering services for business lunches, etc. In many cases, quality and cost considerations are difficult to compare and may require significant lead times to ensure that the requested catering services are provided at the appointed time and place.

Therefore, a management information system which facilitates the selection and matching of contractors with requesters based on a plurality of selection criteria would be a highly desirable.

### SUMMARY

Various exemplary embodiments as described herein addresses the desirable aspects lacking in the relevant art and provides in various exemplary systematic, methodic, and computer program product embodiments a Management Information System (MIS) directed toward online requesting, contractor allocation and in person contract service performance. In an exemplary embodiment, a client-server arrangement is provided in which a plurality of browser equipped client computer systems are in networking communications with a server. The server includes a processor, a memory and a database operatively stored in the memory.

The database is arbitrarily divided into separate components, modules or engines for simplicity of explanation only. A first database component maintains a plurality of contract service records, each contract service record being associated with an individual contractual services provider which includes contractor data representing available contract services and contractor locality information.

A second database component maintains a plurality of individual requester records, each requester record being associated with an individual requestor and includes individual requester data representing a requested contract service and a requestor's locality.

A database engine is operatively loaded into the memory and includes instructions executable by the processor to determine and generate a suggested contractor/requestor allocation in dependence on a correspondence of the data representing a concurrence of service requests and a locality between the contract service and requestor records.

The suggested contractor/requestor allocation is then output in a tiered order of preference of contractors. In an exemplary embodiment, a first tier of the tiered order of preference represents a group of most preferred contractors, a second tier represents a group of second most preferred contractors and a third tier representing a group of third most preferred contractors available for the suggested contractor/requestor allocation.

In an exemplary embodiment, the contract service records further comprises contractor data representing scheduling availability, prior requestor feedback ratings, and requester charge rates; and the requester records further comprises requester data representing requester schedule availability.

In an exemplary embodiment, the database engine further comprises instructions which when executed by the processor cause the processor to generate the suggested contractor/requestor allocation in further dependence on a correspondence of the data representing the data representing provider and requester schedule availability.

In an exemplary embodiment, the database engine further includes instructions which when executed by the processor causes the processor to send a message to each contractor in the first tier which requests acceptance of the suggested contractor/requestor allocation and if no acceptance is received from the first tier contractors within the predetermined time period, send a message to each contractor in the second tier which requests acceptance of the suggested contractor/requestor allocation; if no acceptance is received from the second tier contractors within the predetermined time period, send a message to each contractor in the third tier which requests acceptance of the suggested contractor/requestor allocation; and, if no acceptance is received from the third tier contractors within the predetermined time period, send a message to an administrator.

### BRIEF DESCRIPTION OF THE DRAWINGS

The features and advantages of the exemplary inventive embodiments will become apparent from the following detailed description when considered in conjunction with the accompanying drawings. Where possible, the same reference numerals and characters are used to denote like features, elements, components or portions of the various exemplary embodiments. It is intended that changes and modifications can be made to the various described exemplary embodiments without departing from the broader true scope and spirit of the inventive concept.

FIG. 1—depicts an exemplary block diagram of a server computer system.

FIG. 2—depicts an exemplary block diagram of a networked arrangement in which the server computer system is in networking communications with a plurality of client computer systems.

FIG. 3—depicts an exemplary hierarchical structure of a database associated with a contract services management information system.

FIG. 3A—depicts an exemplary pseudo-programmatic arrangement of the contract services management information system.

FIG. 3B—depicts a plurality of exemplary tables, records or data for requestors, regional service provider and contractors.

FIG. 4—depicts an exemplary process flow chart of the contract services management information system.

FIG. 4A—depicts a continuation of the exemplary process flow chart of the contract services management information system.

### DETAILED DESCRIPTION

In various exemplary embodiments, a Management Information System (MIS) is provided in a Regional Service Provider (RSP) maintains a server which is either internally accessible by only by the RSP or generally accessible by a public network. The network server includes records of contractors which may be organized by service territories. The RSP is responsible for recruiting, evaluating and negotiating terms of service with the contractors within a service territory. The terms of service include financial terms, scheduling guarantees, insurance requirements, bonuses and/or penalties based on requestor feedback, timeliness of responding to an allocated Requestor, etc.

Several business models may be employed by the RSP to receive income for the contractor/requestor allocation services. For example, the RSP may derive income by charging a premium for the services rendered by contractor. In this arrangement, a higher rate is charged to the requester than is billed to the RSP by a contractor. In another example, each requestor subscribes to the RSP as a fee based service. In this arrangement, the requester may be charged on a per transaction basis, on a periodic membership basis or any combination thereof.

In another example, the RSP is paid an enrollment fee for being included in the contractor/requestor allocation services database. Variants of the current example may include receiving an agreed upon percentage of the contractor's service charges paid by the requestor. One skilled in the art would appreciate that various combinations of payments may be received by the RSP from both the contractors and requesters. Additional income may be received from the contractors by providing advertising therefore and/or providing links to the contractors own website.

In general, the RSP recruits, evaluates and enrolls contractors within a given service territory. The contractor evaluation may include financial condition, Better Business Bureau records, state licenses, civil and criminal records, previous customer recommendations and referrals, prior commitments (availability), localities within the service territory in which the contractor will perform contract services, etc. The RSP may also specialize to accommodate a particular industry or business within its service territory.

The types of contractors recruited and maintained by the RSP in the contractor/requestor allocation services database is almost limitless. However, common examples include plumbers, building contractors, carpenters, electricians, appliance repair services, landscapers, cleaning services, movers, paralegals, shipping and delivery services, caterers, etc. From a business perspective, the use of contract service providers reduces overhead costs and simplifies the accounting of the RSP.

It will be appreciated that the MIS may be used but not limited to supporting business operations for other personalized services including the arranging and scheduling of personalized physical fitness training, home healthcare providers, nursing services, consulting services, personnel recruiting services home repairs, lawn maintenance, automobile maintenance, freight shipment and delivery.

Where necessary, computer programs, algorithms and routines are envisioned to be programmed in a high level language object oriented language, for example Java™, C, C++, C#, CORBA, AWK, PERL, Visual Basic™. Database components may utilize any common database program, by way of example and not limitation, ORACLE™, Sequel Server™, MySQL™, SQL™, MS ACCESS™, DB2™, MS FOXBASE™, DBASE™, PostgreSQL™ and RBASE™.

For purposes of this specification, the term “program” is intended to be interpreted in its broadest sense to include all instructions executable by a processor whether embodied in hardware or software. Where applicable, references to various programs may be made in both singular and plural form. No limitation is intended by such grammatical usage as one skilled in the art will appreciate that multiple programs, objects, subprograms, subroutines, algorithms, applets, contexts, etc. may be implemented programmatically to implement the various inventive embodiments.

### Hardware System Configuration

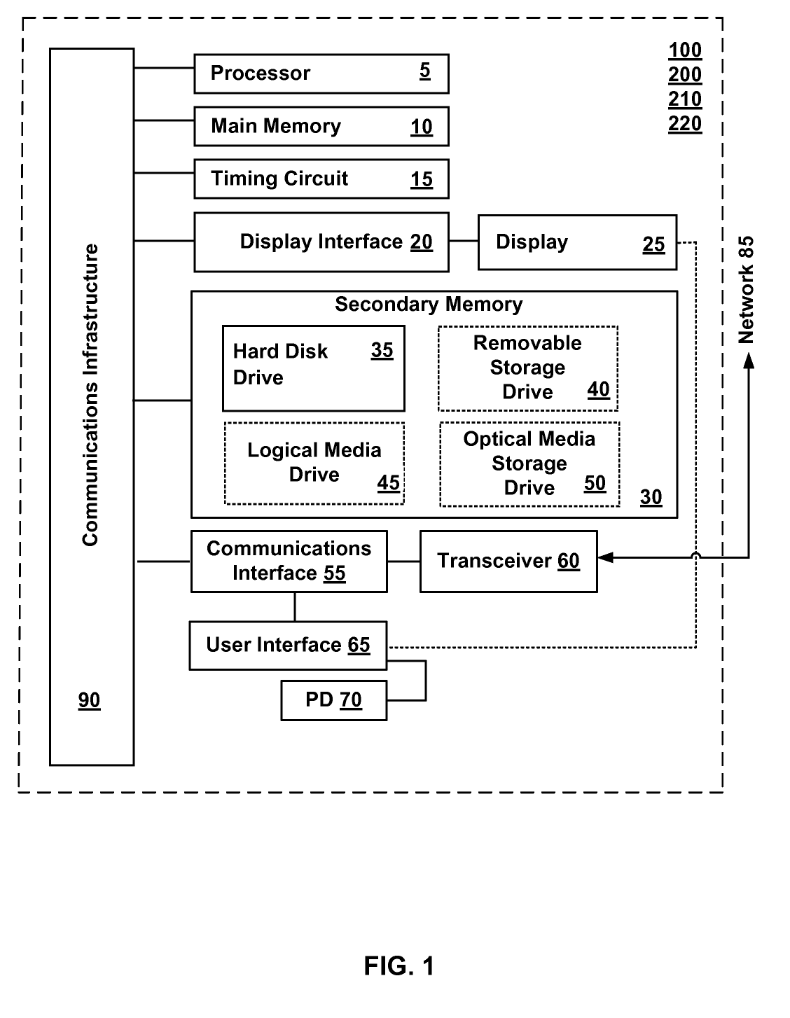

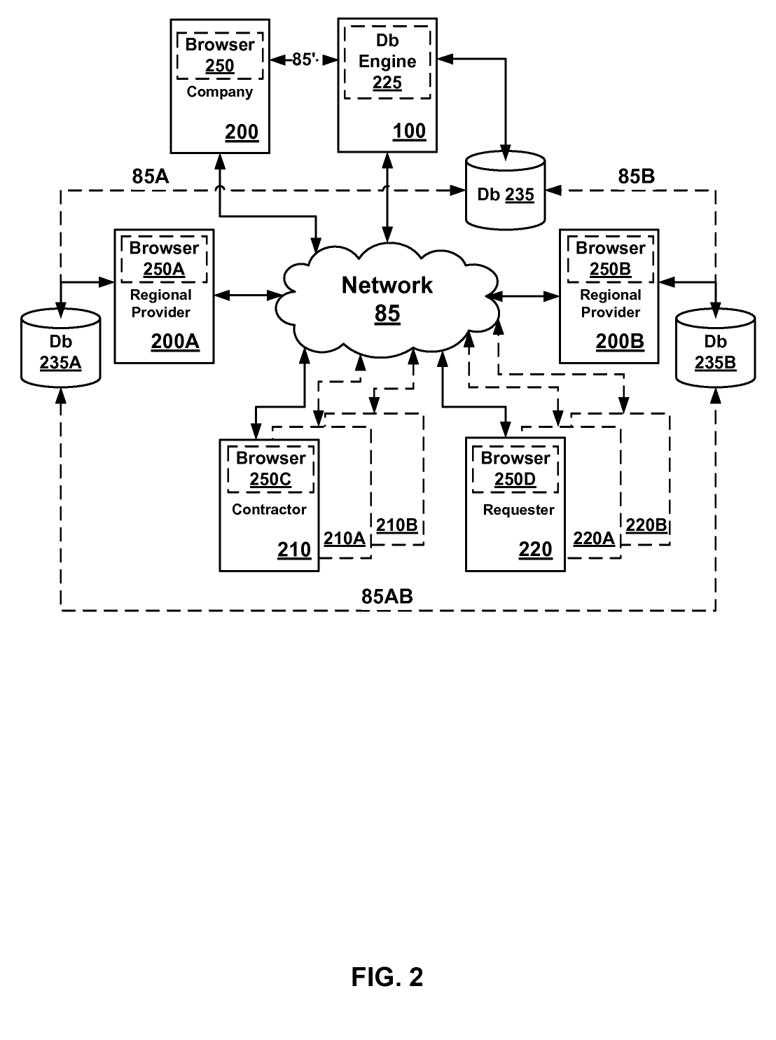

Referring to FIG. 1, a generalized block diagram of an exemplary computer system is depicted. The computer system is illustrative of a server 100 and plurality of networked clients 200, 210, 220 (FIG. 2.) For simplicity and ease of understanding, the term “networked server” 100 will be used hereinafter. However, the same general computer configurations apply to the networked clients 200, 210, 220 as well. The specific functionality of the various computer system implementations will be provided in the discussion accompanying FIG. 2 below.

The networked server 100 includes a communications infrastructure 90 used to transfer data and memory addresses where data files are to be found and control signals among the various components and subsystems associated with the networked server 100. As such, the communications infrastructure 90 provides the input/out (I/O) between and among the various components and subsystems associated with the networked server 100.

A processor 5 is provided to interpret and execute logical instructions stored in the memory 10. One skilled in the art will appreciate that one or more processors 100 may be provided in various server implementations and/or in multi-core integrated processor packages.

The main memory 10 is the primary general purpose storage area for instructions and data to be processed by the processor 5. The term “memory” is to be interpreted in its broadest sense and includes both main memory 10 and secondary memory 30. A collective term of “computer readable storage medium,” may be used to describe either or both the main memory 10 and secondary memory 30 as well.

Where applicable, references to the term “datastore” should be interpreted as an alternative to the terms “memory,” and “computer readable storage medium.” The memory includes the primary 10 and secondary memory 30. A timing circuit 15 is provided to coordinate programmatic activities within the computer 100 in near real time. The timing circuit 15 may be used as a watchdog timer, clock or a counter arrangement and may be separately programmable.

The processor 5, main memory 10 and timing circuit 15 are directly coupled to the communications infrastructure 90. A display interface 20 is provided to drive a display 25 associated with the networked server 100. The display interface 20 is electrically coupled to the communications infrastructure 90 and provides signals to the display 25 for visually outputting both graphical displays and alphanumeric characters.

The display interface 20 may include a dedicated graphics processor and memory (not shown) to support the displaying of graphics intensive media. The display 25 may be of any type (e.g., cathode ray tube, gas plasma) but in most circumstances will usually be a solid state device such as liquid crystal display (LCD.) A secondary memory subsystem 30 is provided which houses retrievable data storage units such as a hard disk drive 35, an optional removable storage drive 40, an optional logical media storage drive 45 and an optional optical media storage drive 50.

The removable storage drive 40 may be a replaceable hard drive, optical media storage drive or a solid state flash RAM device. The logical media storage drive 45 may include a flash RAM device, or an EEPROM encoded with instructions executable by the processor 5. The optical storage media storage drive 50 includes the ability to read and write compact disk (CD) and digital video disk (DVD) media form factors.

A communications interface 55 subsystem is provided which allows for standardized electrical connection of peripheral devices to the communications infrastructure 90 including, PS/2, serial, parallel, USB, and Firewire™ connectivity ports.

For example, a communications network transceiver 60 and a user interface 65 may be electrically coupled to the communications infrastructure 90 via the communications interface 55. The transceiver 60 facilitates the remote exchange of data and synchronizing signals between the networked server 100 and other devices in network communications 85 with the networked server 100. The transceiver 60 is envisioned to be of type normally associated with computer networks based on the various IEEE standards 802.x, where x denotes the various present and evolving wireless computing standards, for example IEEE 802.11; 802.11 a, b, g, n; WiMax IEEE 802.16 and WRANG IEEE 802.22.

Alternately, digital cellular communications formats compatible with for example GSM, 3G, CDMA, TDMA and evolving cellular communications standards. Both peer-to-peer (PPP) and client-server arrangements are envisioned for implementation of the various exemplary embodiments.

For purposes of this specification, the term “user interface” 65 includes the hardware and software by which a user interacts with the networked server 100 and the means by which the networked server 100 conveys information to the user. The user interface 65 may include the display interface 20 and an operatively coupled display 25, for example, inventive embodiments utilizing a touch screen.

The user interface 65 employed may include a pointing device 70 such as a mouse, thumbwheel or track ball, an optional touch screen (not shown); one or more push-button switches (not shown), one or more sliding or circular potentiometer controls (not shown) and one or more additional switches (not shown.)

The user interface 65 provides interrupt signals to the processor 5 via the communications interface 55 and communications infrastructure 90 that may be used to interpret user interactions with the networked server 100. The networked server 100 includes an operating system, the necessary hardware and software drivers necessary to fully utilize the devices coupled to the communications infrastructure 90 and at least an Internet browser 250 (FIG. 2.) The operating system may include the various versions and derivations of Unix™, Microsoft Windows™, and Apple™ MAC OS-X. The Internet browser may be of any common type which is compatible with the operating system installed on the networked server 100.

### Network Topography

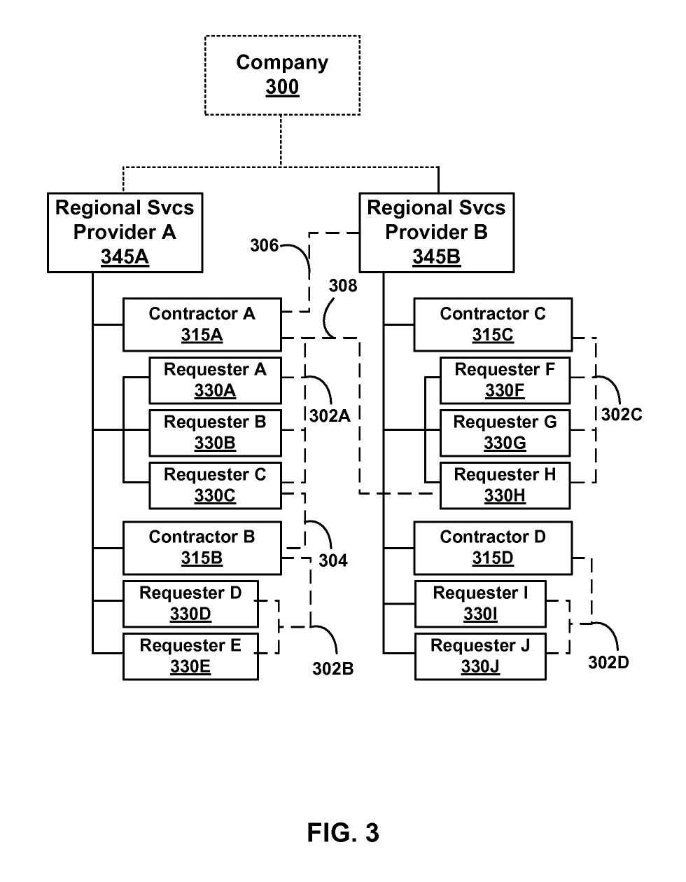

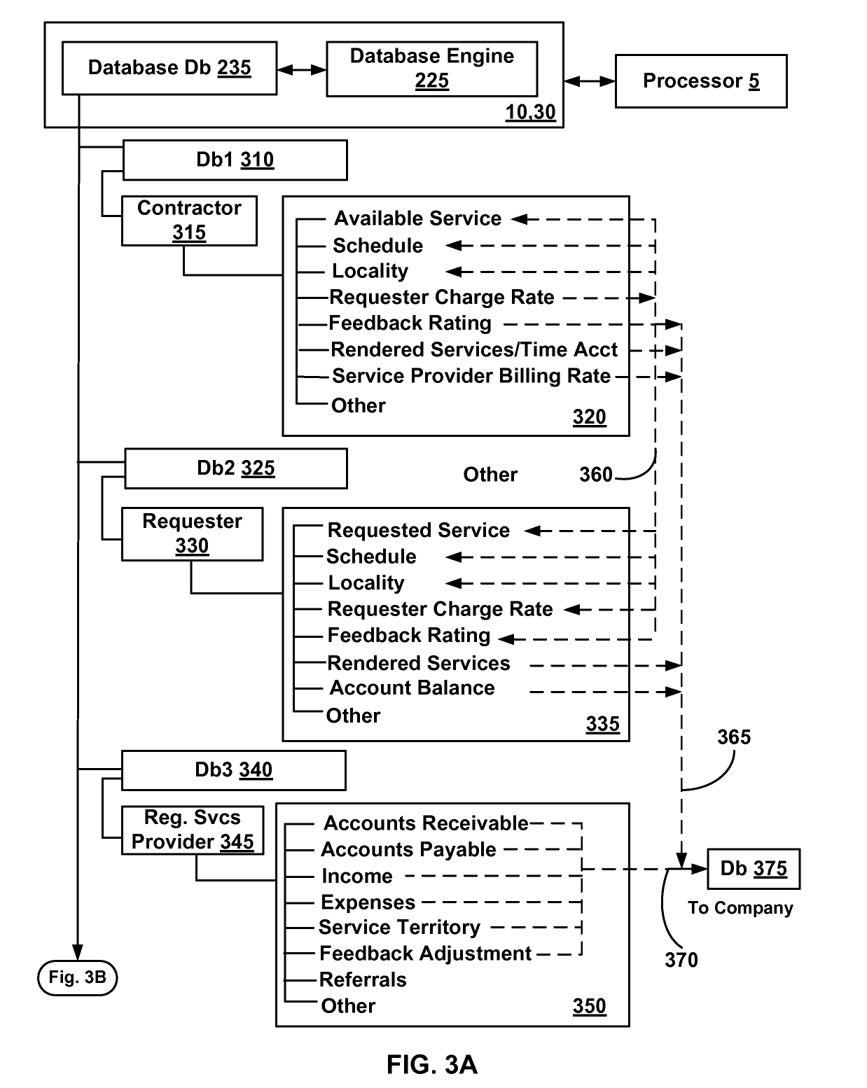

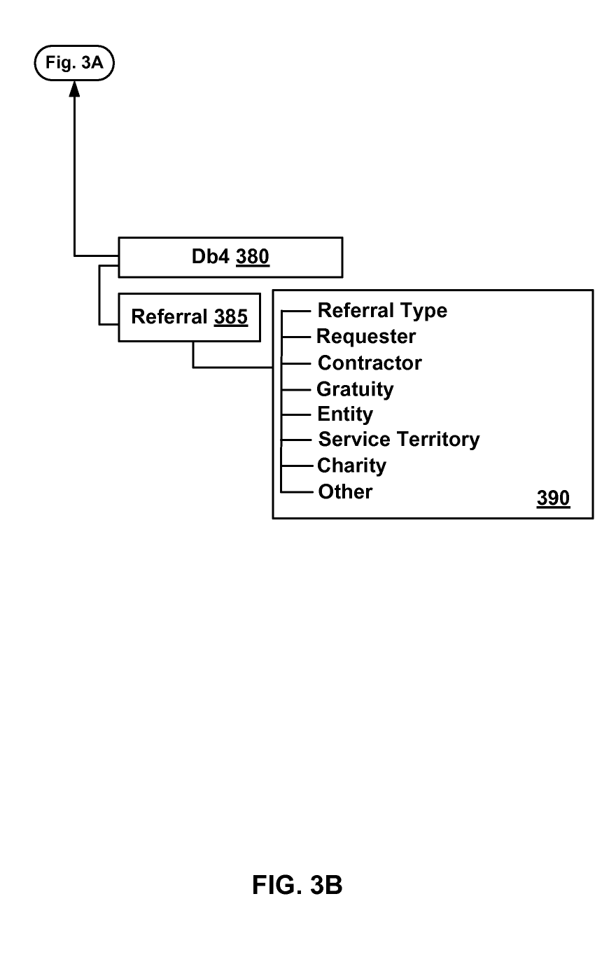

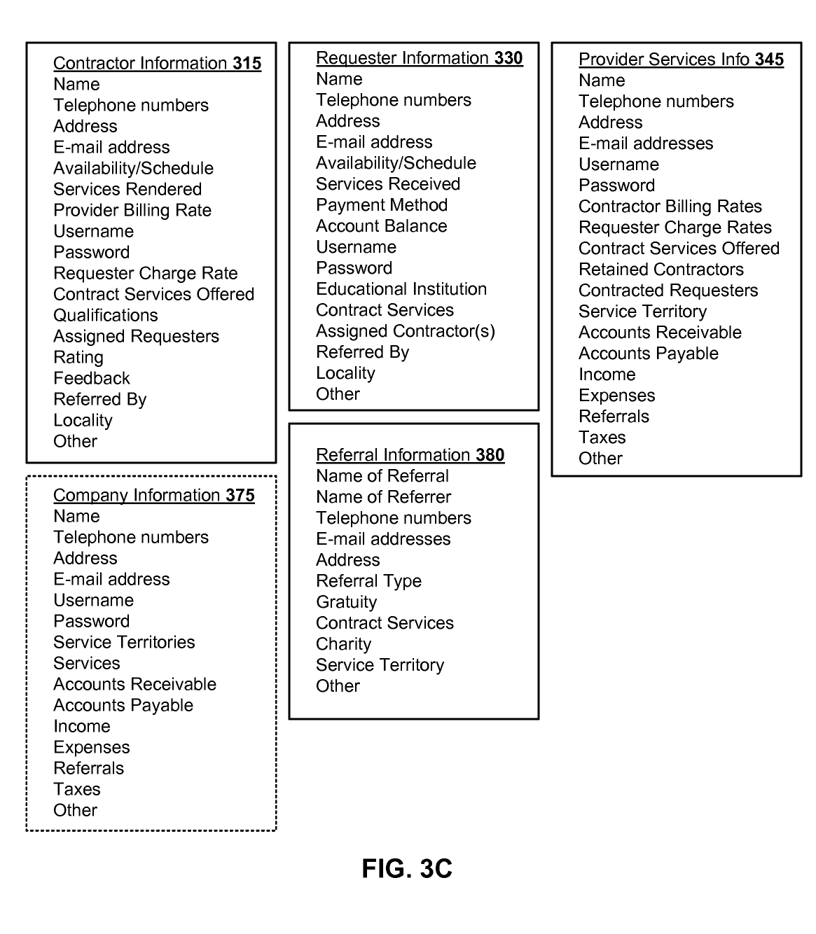

FIG. 2 depicts an exemplary networked arrangement in which a networked server 100 is in networking communications with one or more browser enabled client computer systems 200, 200A,B, 210, 210, 200A,B, 220, 220, 220A,B. The networked server 100 includes a database engine 225 operatively loaded into the memory 10 of the networked server 100. The database engine 225 is functionally coupled to a database 235. The database 235 includes records and data including but not limited business records, available contract services, contractors, contractor's localities, requesters, requested contract services, requester localities, financial and business data and other information and data as is presented in FIG. 3B.

The business records include the RSP's accounts receivable, accounts payable, received income, expenses, and payroll records associated with the RSP's operations within a defined territory. The networked server 100 may be accessed by the RSP client 200 over a private intranet 85′ or via a peer-to-peer communications arrangement. Alternately, the RSP client 200 may access the networked server 100 over a public network 85, for example, the Internet, using a local browser application installed on the client 200.

The networked server 100 may be maintained locally or remotely location from the RSP client 200. Clustering of a plurality of RSP servers 100 may also be accomplished as well to meet throughput demands of a growing business, data security, uptime reliability and redundancy.

The RSP maintains administrator level privileges and may establish access accounts having limited access privileges to the contractors 210A, 210B, 210C and requesters 220A, 220B, 220C on the networked server 100. The limited access accounts allow the contractors and requesters to access their specific records and data but only those records and data specifically authorized by the RSP on the networked server 100.

As part of the networked arrangement, the contractor clients 210A, 210B, 210C are permitted to access the networked server 100 over the public network 85 to receive messages regarding potential contracting opportunities and electronically recording billable time, incurred expenses and requestor feedback. The messages exchanged between the networked server 100 and the provider clients 210A, 210B, 210C include but are not limited to electronic mail (E-mail), short message service text (SMS), and instant messaging text IM. This arrangement allows for time-keeping using electronic “timecards,” which may be submitted to the RSP for approval and payment.

The requester clients 220A, 220B, 210C may likewise be granted limited access to the networked server 100 over the public network 85. Analogous to the contractor arrangement, each requester is provided with the proper user credentials and authentication information to access their assigned account. This allows the requestor to receive notices regarding contractor/requestor allocations, make payments to the RSP and enter feedback on services provided by a contractor into the database 235.

Restricted access to the server 100 may be accomplished by assigning the contractors and requestors with a usernames and passwords, digital certificates, or two factor authentication tokens.

### Contractor/Requestor Allocation Database

FIG. 3 depicts an exemplary hierarchical structure of a contractor/requestor allocation database 235. The contractor/requestor allocation database 235 is maintained by the Regional Service Provider 200. The RSP 200 has a plurality of contractors 210A, 210B, 210C who have entered into a contractual relationship with the RSP 200 and may be provided with limited access to the Company database 235 as was previously described. Requestors 220A, 220B, 220C may receive contract services from one or more of the contractors 210A, 210B, 210C depending on their individual needs.

The requesters 220A, 220B, 220C usually contract with the RSP 200 based on the requestor's locality within a Regional Service Providers service territory. The service territory may be arbitrarily defined but common regional designations such as states, counties, parishes, city limits, population size, zip codes, area codes, geographical boundaries, business types, standard industry codes (SIC) and geographical coordinates.

The contractor/requestor database 100 attempts to match a requester 220A, 220B, 220C with one or more contractors 210A, 210B, 210C based on minimum criteria of contract services requested and offered by the contractors and locality of the requester and contractor. The locality may utilize the same criteria as the service territory or may be further limited by estimated travel times, distances between the requestor and contractor or any combination of the service territory criteria. Where possible, several alternatives contractor/requestor allocations are generated to ensure contractor availability and/or allowing the requester to individually choose a known contractor.

FIG. 3A depicts an exemplary pseudo-programmatic arrangement where a contractor/requestor allocation database engine 225 is coupled to a Regional Service Providers (RSP) database 235. The database engine 235 is operatively installed in the memory 10, 30 of a networked server 100. The database engine 225 includes instructions executable by the processor 5 to perform a contractor/requestor allocation 360 in dependence on a minimum correspondence of contract service subject matter and a locality 360. Further refinements to the matching criteria, for example, a correspondence of the requestor and service provider availability schedule(s), contractor feedback ratings and/or contractor charge rates to the requestor may also be incorporated into the contractor/requestor allocation.

In an exemplary embodiment, the Company database 235 comprises three components. The first component 310 comprises contract service records 315. The contract service records 315 includes one or more available contract services in which each contractor is qualified to provide, availability schedule of the contractor, requestor charge rate, RSP billing rate, requestor feedback information, contract service sessions provided, the locality in which a contractor has agreed to provide contract services and a general comments field. An exemplary table of provider information is provided in FIG. 3B.

A second database component 325 comprises requestor records 330. The requestor records 330 includes one or more requests for contract services including the requested contract service(s), availability schedule of the requester, locality of the requester, requestor charge rate, feedback rating of the contractor, services rendered to the requester, account balance of the requestor and other pertinent informational records. An exemplary table of requestor information is provided in FIG. 3B.

A third database component 340 comprises the RSP records 345. The RSP records 345 includes accounts receivable, accounts payable, income received from requesters, expenses paid by the RSP, service territory, a contractor feedback payment adjustment and a general comments field. An exemplary table of Regional Service Provider information is provided in FIG. 3B.

In an exemplary session, a registered requestor 330 is seeking contract services which causes the database engine 225 to query the database 235 in an attempt to match the contract services desired by the requestor and a contractor qualified to provide the contract services to the requestor within a common locality. The requestor may further specify additional filtering criteria such as charge rates, feedback ratings and/or correspondence of availability schedules. The database engine 225 outputs all of the contractors which match the filtering criteria provided by the requestor in a tiered hierarchy ranging from most preferable matches to least preferable matches.

Referring to FIG. 3B, exemplary tables comprising Contract Services Information 315, Requestor Information 330 and Regional Service Provider Information is depicted. Contract services information 315 comprises the name of the contractor, one or more telephone numbers associated with the contractor, the contractor's mailing address, one or more E-mail addresses of the contractor, the contractor's availability schedule, contract services provided by the contractor, the contractor's billing rate to the Regional Service Provider, the username and password provided to the contractor to access the database 235, the contract services provided by the contractor, the qualifications of contractor, requestors assigned to the contractor, a subjective rating of the contractor, feedback provided by requestors related to contractor performance, the locality in which the contractor has contractually agreed to provide contract services and other pertinent information.

Requestor information 330 comprises the name of the requestor, one or more telephone numbers associated with the requestor, the requestor address, one or more e-mail addresses of the requester, the requestor's availability schedule, contract services received by the requester, the payment method, account balance, the username and password provided to the requester, the contract services being requested by the requester, contractors assigned to the requestor and the locality in which the requestor is disposed.

Regional Service Provider information 345 comprises the name of the RSP, one or more telephone numbers associated with the individual or entity operating the RSP, the RSP's mailing address, one or more e-mail addresses of the RSP, the username and password of the RSP, contractor billing rates, requestor charge rates, contract services offered by the RSP, contracted requestors, retained contractors, service territory, accounts receivable, accounts payable, income, expenses, taxes and a general information field.

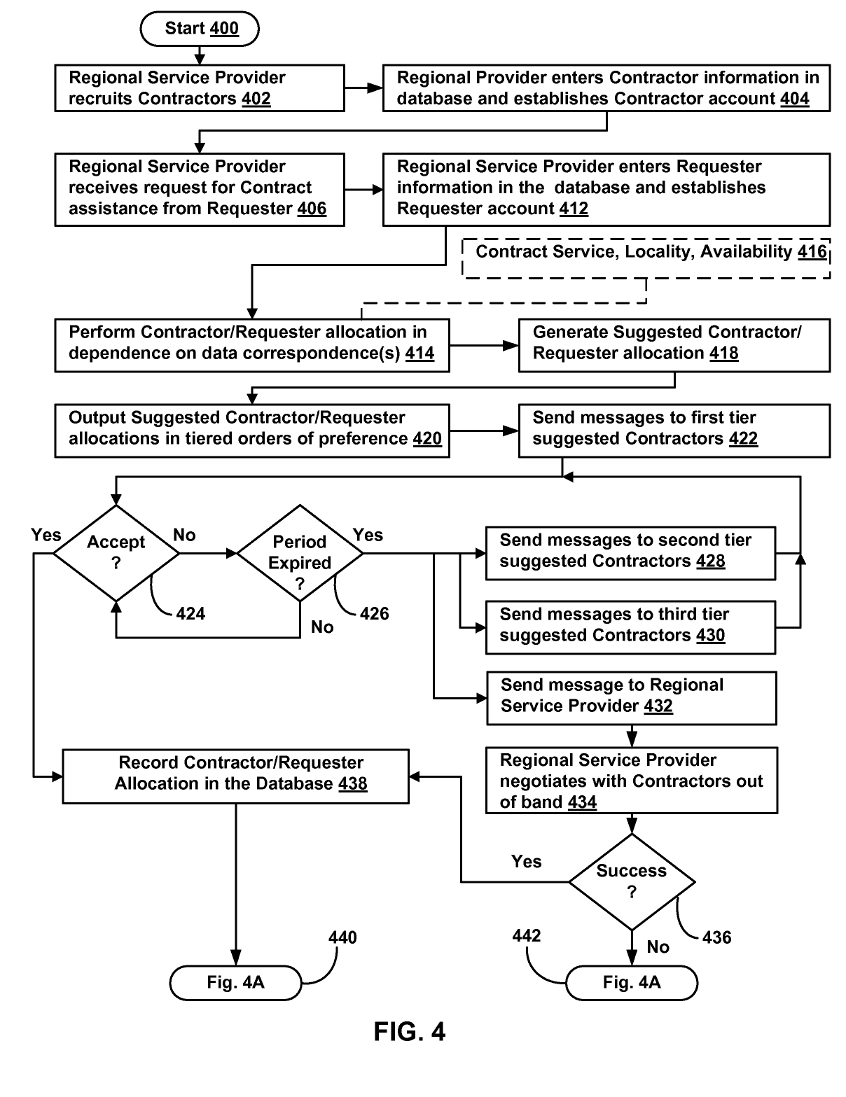

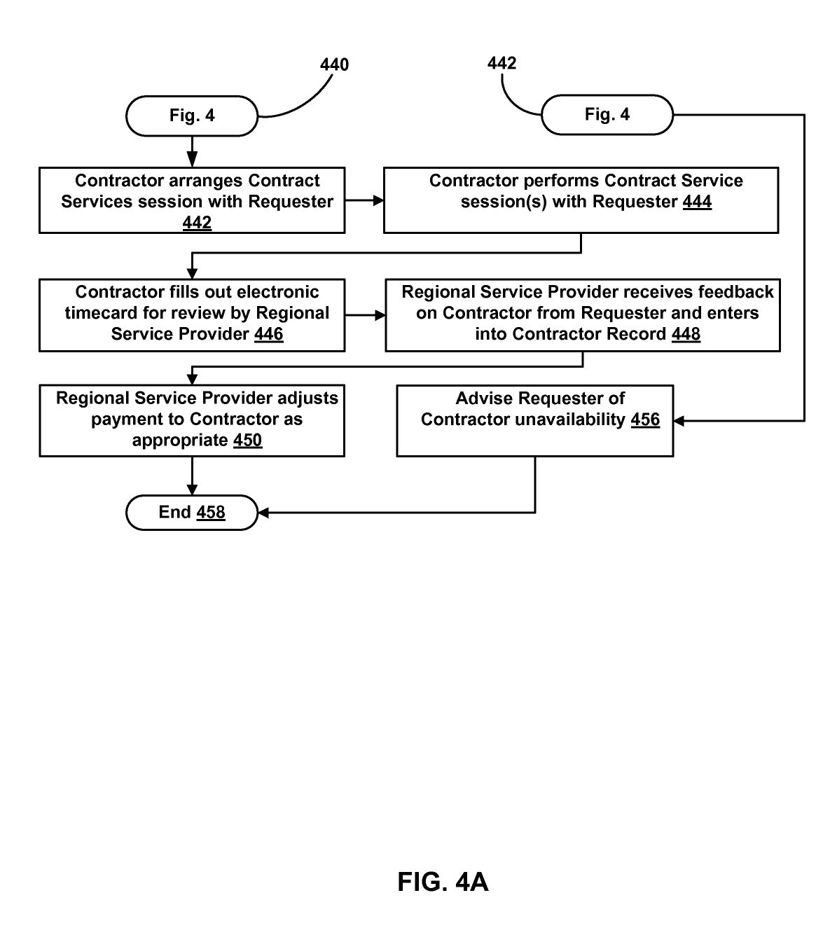

FIG. 4 depicts an exemplary processing implementation of the contractor/requestor allocation management information system (MIS.) The process is initiated 400 by a Regional Service Provider (RSP) recruiting contractors 402 to provide contract services to requestors. Recruiting of contractors may be accomplished by traditional advertising methods and/or via web postings. The RSP may initially enter the contractor's information into the database 404. In an exemplary embodiment, the RSP may establish an account for each recruited contractor which allows direct entry and updates and/or changes to the information to be entered directly by the contractors for which the access accounts has been established 405.

When the RSP receives a request for contract services from a requestor 406, the requester information is recorded in the Company database 412.

Analogously, the RSP may establish an account for the requestor which allows future updates and/or changes to the requestor information to be entered directly by the requester for which the access account has been established 405. The contractor and requester information includes some or all of the information shown in FIG. 3B.

The RSP then performs a contractor/requestor allocation using the database 414. The database attempts to find correspondences between the requester and contract services records. As a minimum, requested contract services and localities are initially compared. In addition, the availability of the contractor and requestor are matched to ensure that the initially allocated service provider can meet with the requester 416. Other considerations such as contractor feedback ratings, contractor charge rates, and RSP billing rates may also be incorporated into the contractor/requestor allocation as is shown in FIG. 3A. The database engine generates a suggested contractor/requestor allocation 418. The suggested contractors generated by the contractor/requestor allocation are output into a plurality of tiers 420. A first tier represents the most preferable contractors, the second tier represents the second most preferable contractors and the third tier represents the third most preferable contractors. The database engine then sends an electronic message to each contractor in the first tier. The first tier contractors providers may electronically accept the suggested contractor/requestor allocation. The database assigns the first responding contractor to the requestor. A preset time period is established which allows the first tier contractors to electronically respond.

A typical time period is approximately 8 hours, however, any reasonable time period may be used as well. An acceptance 424 by a contractor is recorded in the database as a Contractor/Requestor Allocation 438. The process continues 440 as provided in the discussion accompanying FIG. 4A.

If an acceptance 424 is not received with the predetermined time period 426, a second set of messages are then sent to each contractor included in the second tier 428. As with the first tier contractors, a second tier contractor may electronically accept the suggested Contractor/Requestor allocation. As before, the database assigns the first responding contractor to the requestor. Again, if an acceptance 424 is not received within the predetermined time period 426, a third set of messages are then sent to each contractor included in the third tier 430.

As before, the database assigns the first responding contractor in the third tier to the requestor. However, if no contractors electronically accept the suggested contractor/requestor allocation 424 and the predetermined time period has expired 426, the database sends an electronic message to an RSP Administrator 432. The RSP Administrator will then attempt to negotiate with one or more of the contractors out of band; typically by telephone, to accept the suggested Contractor/Requestor allocation. If the Administrator is successful 436 in negotiating a contractor to provide services to the requester, the RSP Administrator records the negotiated Contractor/Requestor Allocation 438 in the database. However, if the RSP Administrator is not successful 436 in obtaining a contractor for the requester, the process continues 442 as provided in the discussion accompanying FIG. 4A.

Referring to FIG. 4A, the process continues after a Contractor/Requestor Allocation is recorded in the database 438 by the allocated contractor contacting the requester and arranging one or more contract service sessions with the requestor 442. The contractor then performs the one or more contract service sessions with the requester 444. The contractor electronically fills out an electronic timecard for the rendered contract services and electronically submits the timecard 446 to the RSP. In an exemplary embodiment, the requestor may also enter feedback comments on the contractor's performance 448 which is recorded in the contract service records portion of the database. The RSP reviews the contractor's submitted timecard and any feedback received from the requestor. If the feedback is positive, the contractor may earn a bonus. Alternately, if the feedback is extremely negative, the contractor may have a deduction applied to his or her payment 450. In the continuing situation where the RSP Administrator is unable to obtain a contractor for a requester 442, the RSP Administrator informs the requester 456, typically out of band, and advises him or her of the lack of contractor availably which ends the process 458, until a new cycle is initiated.

This various exemplary inventive embodiments described herein are intended to be merely illustrative of the principles underlying the inventive concept. It is therefore contemplated that various modifications of the disclosed embodiments will, without departing from the inventive spirit and scope, be apparent to persons of ordinary skill in the art. They are not intended to limit the inventive embodiments to any precise form described. In particular, it is contemplated that functional implementation of the various inventive embodiments described herein may be implemented equivalently in hardware, software, firmware, and/or other available functional components or building blocks. No specific limitation is intended to a particular arrangement or programmatic sequence. Other variations and inventive embodiments are possible in light of above teachings, and it is not intended that this Detailed Description limit the inventive scope, but rather by the Claims following herein.

What is claimed:

1. A system for automatically allocating contractors with requestors comprising:
a server operatively coupled to a communications network comprising;
a processor;
a computer readable storage medium operatively coupled to the processor;
a database operatively stored in the computer readable storage medium, the database comprising;
a first database component operative to provide a plurality of contract service records, each contract service record being associated with a contractor, and including contractor data representing an available contract service and a contractor locality;
a second database component operative to provide a plurality of request records, each request record being associated with a requestor and including requestor data representing a requested contract service and a requestor locality;
a database engine operatively loaded into the computer readable storage medium including instructions which when executed by the processor causes the processor for;
determining a suggested contractor/requestor allocation in dependence on correspondences of the data representing the available contract service and the data representing the requested contract service and the contractor locality and the requestor locality; and,
outputting the suggested contractor/requestor allocation in a tiered order of preference.

2. The system according to claim 1 further comprising a client computer in networking communications with the server and configured to allow remote entry into the database data representing one of;, the request records and the contract service records.

3. The system according to claim 2 wherein one of the contract service records and the request records are entered by a regional service provider in privity with one of a contractor or a requester.

4. The system according to claim 2 wherein one of the contract service records and the request records are entered by one of a contractor and a requester in privity with a regional service provider.

5. The system according to claim 1 wherein a first tier of the tiered order of preference represents a most preferred contractor, a second tier represents a second most preferred contractor and a third tier represents a third most preferred contractor.

6. The system according to claim 1 wherein each contract service record and each request record further comprises data representing a contractor availability schedule and a requester availability schedule.

7. The system according to claim 6 further comprising instructions which when executed by the processor, causes the processor to determine the suggested contractor/requestor allocation in further dependence on correspondences of the data representing a contractor availability schedule and a requestor availability schedule.

8. The system according to claim 5 wherein the database engine further comprises instructions which when executed by the processor causes the processor to;
send a message over the network to a contractor in the first tier which requests acceptance of the suggested contractor/requestor allocation; and,
if no acceptance is received from a contractor in the first tier within the predetermined time period, send a message to a contractor in the second tier which requests acceptance of the suggested contractor/requestor allocation;
if no acceptance is received from the contractors in the second tier within the predetermined time period, send a message to a contractor in the third tier which requests acceptance of the suggested contractor/requestor allocation; and,
if no acceptance is received from a contractor in the third tier within the predetermined time period, send a message to an administrator.

9. The system according to claim 1 wherein each contract service record further comprises contractor feedback rating data and requester charge rate data.

10. The system according to claim 9 wherein the database engine further comprises instructions which when executed by the processor causes the processor to determine the suggested contractor/requestor allocation in further dependence on one of the contractor rating data and the contractor feedback rating data.

11. A computer implemented method comprising:
providing a plurality of contract service records in a network accessible database, each contract service record being associated with a contractor, and including contractor data representing an available contract service and a contractor locality;
providing a plurality requester records in the database, each requestor record being associated with a requestor, and including requestor data representing a requested contract service and a requestor locality;
determining a suggested contractor/requestor allocation in dependence on correspondences of the data representing the available contract service and the requested contract service and the contractor locality and the requestor locality; and,
outputting the suggested contractor/requestor allocation such that each contractor included in the suggested contractor/requestor allocation is output in a tiered order of preference.

12. The computer implemented method according to claim 11 wherein a first tier of the tiered order of preference represents a most preferred contractor, a second tier represents a second most preferred contractor and a third tier represents a third most preferred contractor.

13. The computer implemented method according to claim 12 wherein each contract service record and each requester record further comprises data representing a contractor availability schedule and a requestor availability schedule.

14. The computer implemented method according to claim 13 further comprising determining the suggested contractor/requestor allocation in further dependence on correspondences of the data representing the contractor availability schedule and the requestor availability schedule.

15. The computer implemented method according to claim 12 further comprising;
sending a message to a contractor in the first tier which requests acceptance of the suggested contractor/requestor allocation;
if no acceptance is received from the first tier contractors within a predetermined time period, sending a message to a contractor in the second tier requesting acceptance of the suggested contractor/requestor allocation;
if no acceptance is received from the second tier contractors within the predetermined time period, sending a message to a contractor in the third tier which requests acceptance of the suggested contractor/requestor allocation; and,
if no acceptance is received from a contractor in the third tier within the predetermined time period, sending a message to an administrator.

16. The computer implemented method according to claim 11 wherein each contract service record further comprises data representing contractor feedback ratings and requester charge rates.

17. The computer implemented method according to claim 16 further comprising determining the suggested contractor/requestor allocation in further dependence on one of the data representing contractor feedback ratings and the data representing requester charge rates.

18. The computer implemented method according to claim 11 wherein each contract service record and each request record further comprises data representing a contractor availability schedule and a requestor availability schedule.

19. The computer implemented method according to claim 18 further comprising determining the suggested contractor/requestor allocation in further dependence on correspondences of the data representing the contractor availability schedule and the requestor availability schedule.

20. A computer program product embodied in a tangible form comprising instructions which when executed by a processor coupled to a network, causes the processor to:
store a network accessible database in a computer readable storage medium coupled to the processor;
provide a plurality of contract service records in the database, each contract service record being associated with a contractor and including contractor data representing an available contract service and a contractor locality;
provide a plurality of requester records in the database, each request record being associated with a requester and including requester data representing a requested contract service and a requestor locality;
determine a suggested contractor/requestor allocation in dependence on a correspondence of the data representing a requested contract service and an available contraction service and a requestor locality and contractor locality; and,
output the suggested contractor/requestor allocation such that each contractor of the suggested contractor/requestor allocation is output in a tiered order of preference.
